(19) United States
(12) Patent Application Publication
(10) Pub. No.: US 2002/0037796 A1
(43) Pub. Date: Mar. 28, 2002

(54) Cushioning conversion machine with software controlled motor

(76) Inventors: Joseph J. Harding, Mentor, OH (US); Kevin W. Park, Chardon, OH (US)

Correspondence Address: M. David Galin, Renner, Otto, Boisselle & Sklar, LLP, 1621 Euclid Avenue, Nineteenth Floor, Cleveland, OH, 44115-2191, US

(21) Appl. No.: 09/963,086

(22) Filed: Sep. 25, 2001

Related U.S. Application Data
(60) Provisional application No. 60/235,258, filed on Sep. 25, 2000.

(51) Int. Cl. B31F 5/02

(52) U.S. Cl. 493/967; 493/350

(57) ABSTRACT

A cushioning conversion system for converting a sheet-like stock material into a section of dunnage. The system has a feed motor operatively connected to advance the stock material under the control of a motor control signal, the motor control signal having a series of sequential values corresponding to either a motor power on state or a motor power off state; and a controller, the controller generating the motor control signal by executing a motor control logic routine.

### RELATED APPLICATION(S)

This application claims the benefit of U.S. Provisional Patent Application Serial No. 60/235,258, filed Sep. 25, 2000, titled “Cushioning Conversion Machine With Software Controlled Motor”, the disclosure of which is herein incorporated by reference in its entirety.

### TECHNICAL FIELD

The present invention relates to a cushioning conversion system (dunnage converter) which converts sheet stock material into cushioning material. More particularly, the present invention relates to a cushioning conversion system including a feed motor having its speed controlled by software.

### BACKGROUND ART

In the process of shipping a part from one location to another, a protective packaging material is typically placed in the shipping container to fill any voids, provide blocking and bracing, and/or to cushion the part during the shipping process. Some commonly used protective packaging materials are plastic or cellulose foam peanuts, plastic bubble wrap, shredded paper or cardboard, and converted paper pads. Converted paper pads, being made from paper and particularly kraft paper, are biodegradable, recyclable and composed of a renewable resource. Consequently, converted paper pads have become increasingly important in light of many industries adopting more progressive policies in terms of environmental responsibility. The conversion of paper sheet stock material into relatively low density paper pads may be accomplished by a cushioning conversion machine, such as those disclosed in U.S. Pat. Nos. 4,026,198; 4,085,662; 4,109,040; 4,237,776; 4,557,716; 4,650,456; 4,717,613; 4,750,896; 4,968,291; 4,884,999; 5,123,889; 5,607,383; 5,836,538; and 5,897,478. The foregoing patents are all assigned to the Assignee of the present invention and their entire disclosures are incorporated herein by reference.

The paper typically is dispensed from a freely rotating roll of sheet stock having multiple plies. The paper is fed through a forming assembly and then a feeding/connecting assembly powered by a feed motor. The feeding/connecting assembly has a pair of intermeshing coining gears that, when rotated, advance the material being converted. Power is applied to the feed motor to cause the motor's rotation and to turn the gears, thereby advancing the material. Once an appropriate length of converted cushioning material has been generated, the feed motor is stopped and the cushioning material is cut with a severing or cutting assembly. Accordingly, the supply roll accelerates and decelerates each time the gears are started and stopped during the conversion process. This results in changes in the tension of the stock material.

A well known problem in the art is tearing of the paper as the feed motor starts to pull the sheet stock material from the supply roll. This is due, in large part, to the rotational inertia of the supply roll tending to overrun and creating slack in the stock material at the supply end of the conversion machine when the feed motor stops. As the feed motor starts up to generate the next cushioning pad, the feed motor advances the stock material (which has a relatively low tension) and takes up the noted slack in the sheet stock material. After the slack has been taken up, the tension on the stock material will rapidly increase, almost instantaneously, until the supply roll accelerates to match the feed rate through the machine. If the change in tension is great enough, the stock material will have a tendency to snap and/or tear before the supply roll begins to rotate. The tears may adversely affect the quality of the dunnage product being produced. Tearing most frequently occurs along the edges of one or more of the plies of the sheet material. As one skilled in the art can appreciate, tearing of the sheet material is undesirable and many mechanical approaches have been attempted to reduce or eliminate the amount of tearing of the sheet material. The previously attempted solutions typically involve the addition of dampeners and other mechanical apparatus.

### SUMMARY OF THE INVENTION

According to one aspect of the invention, the invention is a cushioning conversion system for converting a sheet-like stock material into a section of dunnage. The system has a feed motor operatively connected to advance the stock material; and a controller for controlling the speed of the feed motor, the controller progressively increasing the speed of the feed motor at the beginning of a dunnage generation cycle.

According to another aspect of the invention, the invention is a cushioning conversion system for converting a sheet-like stock material into a section of dunnage. The system has a feed motor operatively connected to advance the stock material under the control of a motor control signal, the motor control signal having a series of sequential values corresponding to either a motor power on state or a motor power off state; and a controller, the controller generating the motor control signal by executing a motor control logic routine.

According to another aspect of the invention, the invention is a method of controlling a cushioning conversion machine. The method includes the steps of generating a motor control signal, the motor control signal having a series of sequential values corresponding to either a motor power on state or a motor power off state; and operatively applying the motor control signal to a triac to selectively place the triac in the motor on state or the motor off state, the triac being coupled to a feed motor connected to advance a web of stock material, and the triac controlling during which of a plurality of AC power half cycles the motor receives power.

According to yet another aspect of the invention, the invention is a method of controlling a cushioning conversion machine. The method includes the steps of executing a motor control logic routine to generate a motor control signal, the motor control signal having a series of sequential values corresponding to either a motor power on state or a motor power off state; and controlling the speed of a feed motor connected to advance a web of stock material with motor control signal; wherein for each value of the motor control signal, the motor control logic routine includes the steps of: reading a predetermined signal value from a data table; and outputting the motor control signal corresponding to the signal value.

According to still another aspect of the invention, the invention is a motor control system. The system has a processor, the processor being programmed to read a series of predetermined sequential values corresponding to either a motor power on state or a motor power off state from a memory; and a signal driver, the signal driver outputting a motor control signal corresponding to the sequential values read by the processor, the motor control signal being effective to control the rotational speed of a motor.

### BRIEF DESCRIPTION OF DRAWINGS

These and further features of the present invention will be apparent with reference to the following description and drawings, wherein:

FIG. 1 is a schematic illustration of a packaging system according to the present invention including a cushioning conversion machine and a conversion machine system controller;

FIG. 2 is a block diagram of the conversion system controller and its coupling to a feed motor;

FIG. 3 is a flowchart of a motor control logic; and

FIG. 4 is an exemplary data table used by the motor control logic.

### DISCLOSURE OF INVENTION

In the detailed description which follows, identical components have been given the same reference numerals, regardless of whether they are shown in different embodiments of the present invention. To illustrate the present invention in a clear and concise manner, the drawings may not necessarily be to scale and certain features may be shown in somewhat schematic form.

Briefly, the present invention is directed to controlling the acceleration of a feed motor that is operatively connected to advance stock material in a cushioning conversion system for converting the stock material into a section of dunnage. The rotational speed of the motor, controlled by a motor control signal, is composed of a series of sequential values corresponding to either a motor power on state or a motor power off state. A controller is used to generate the motor control signal by executing a motor control logic routine. The motor control logic includes the steps of reading a signal value from a data table and outputting a motor control signal corresponding to the signal value. The motor control logic also includes determining whether the soft start is complete and running the feed motor at a steady state upon completion of the soft start. The motor control signal is output from the controller via a signal driver and applied to a control triac. In a preferred embodiment, the control triac is an optical isolator. The motor control signal places the control triac in either a motor on state or the motor off state. The control triac controls a power triac which selectively supplies AC power to the motor based on whether the control triac is in the motor on state of the motor off state. The triac arrangement can control which AC cycles, and more specifically which half cycles, of an AC power supply are supplied to the feed motor.

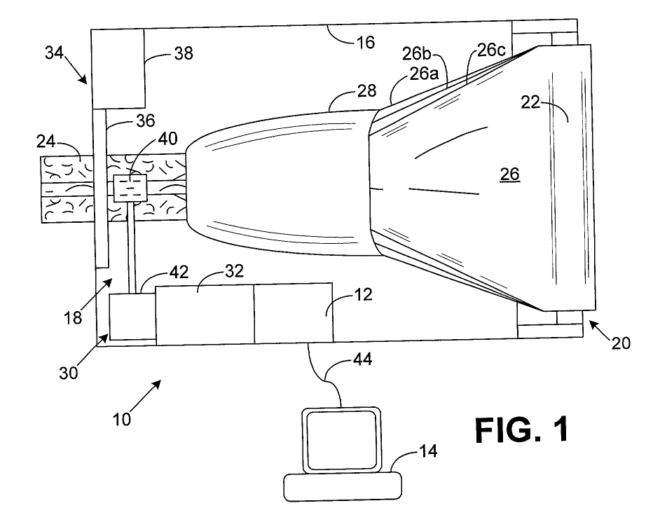

Referring now to the drawings in detail, and initially to FIG. 1, a cushioning conversion machine 10 is schematically shown. The cushioning conversion machine 10 generates packing material to be used in packaging parts in containers. The cushioning conversion machine 10 includes a controller 12 for controlling the various operational components within the cushioning conversion machine 10 as will be discussed in greater detail below. The system controller 12 may be coupled to an external controller terminal 14 for acting as a user interface to the cushioning conversion machine 10. It should also be appreciated that the cushioning conversion machine 10 can also be coupled to remote computing devices via a network or data communications device. The controller terminal 14 may operate, for example, to retrieve a predetermined set of packing instructions in response to the identification of a part to be packaged as is described in greater detail in co-owned U.S. patent application Ser. No. 09/096,123 filed Jun. 11, 1998, which is incorporated herein by reference in its entirety. It should be appreciated that one of the controller 12 or the terminal 14 can be eliminated in favor of the other, where the remaining device takes over the processing and control functions of the other.

The cushioning conversion machine 10 preferably includes a frame 16 upon which the various components of a conversion assembly 18 and the system controller 12 are mounted. The frame 16 has mounted thereto, or included thereon, a stock supply assembly 20, including a web separating assembly (not shown) and stock support bar (not shown) which holds a roll of stock material 22 for conversion by the conversion assembly 18 into a cushioning material pad 24, or section of dunnage. The roll of stock 22 is, for example, web material such as kraft paper 26, although the principles of the invention have application with other types of sheet stock material. The stock material 26 can have one, two or more plies, such as the three plies 26a, 26b and 2c illustrated in FIG. 1.

The illustrated conversion assembly 18 is composed of plural conversion assemblies including a forming assembly 28, a feeding/connecting assembly 30 powered by a feed motor 32, and a severing or cutting assembly 34 having a cutter 36 powered by a cut motor 38. The cutter 36 is selectively engaged by a clutch (not shown) controlled by the system controller 12. Also provided, but not illustrated, is a post-cutting constraining assembly, or outlet, for guiding the cushioning material from the cutting assembly 34. As mentioned, the feeding assembly 30 is powered by the feed motor 32. More specifically, the feed motor rotatably drives a pair of opposed, intermeshed gear-like members, or coining gears 40, by way of a drive train 42. One of the coining gears 40 is disposed above the paper 26 and the other of the coining gears 40 is disposed below the paper 26 and thus not shown here.

During the conversion process, the forming assembly 28 causes the lateral edges of the paper 26 to turn inwardly to form a continuous strip having two lateral pillow-like portions and a central band therebetween as such stock material 22 is advanced through the forming assembly 28. The feeding/connecting assembly 30 performs a feeding, e.g. pulling, function by drawing the continuous strip of stock material 22 through the nip of the two cooperating gears 40 for a duration which is determined by the length of time that the feed motor 32 rotates the gears 40. The feeding/connecting assembly 30 additionally performs a “connecting” function as the gears 40 coin and/or perforate the central band of the material strip as it passes therethrough to form a coined strip. As the coined strip travels downstream through the feeding/connecting assembly 30, the cutting assembly 34 cuts the strip into sections of a desired length. These cut sections exit from the post-cutting constraining assembly and are then available for use in the packaging of a part.

The system controller 12 is preferably a microprocessor-based programmable controller. The system controller 12 controls the operation of the various components of the cushioning conversion machine 10 to form one or more pads 24 of particular lengths in accordance with a number of control input signals. Such control signal inputs may include inputs from machine sensors, such as may be employed to detect jams or accurately measure pad length formation, and inputs from the controller terminal 14 via a control line 44. When it is desired that an appropriate length of pad be formed, the system controller 12 causes power to be supplied to the feed motor 32 for a duration which is sufficient for the conversion assembly 18 to produce the desired length of pad. Power to the feed motor 32 is then disabled and the system controller 12 causes the cut motor clutch to operatively engage the cut motor 38 with the cutter 36 to sever the pad 24 at the desired length.

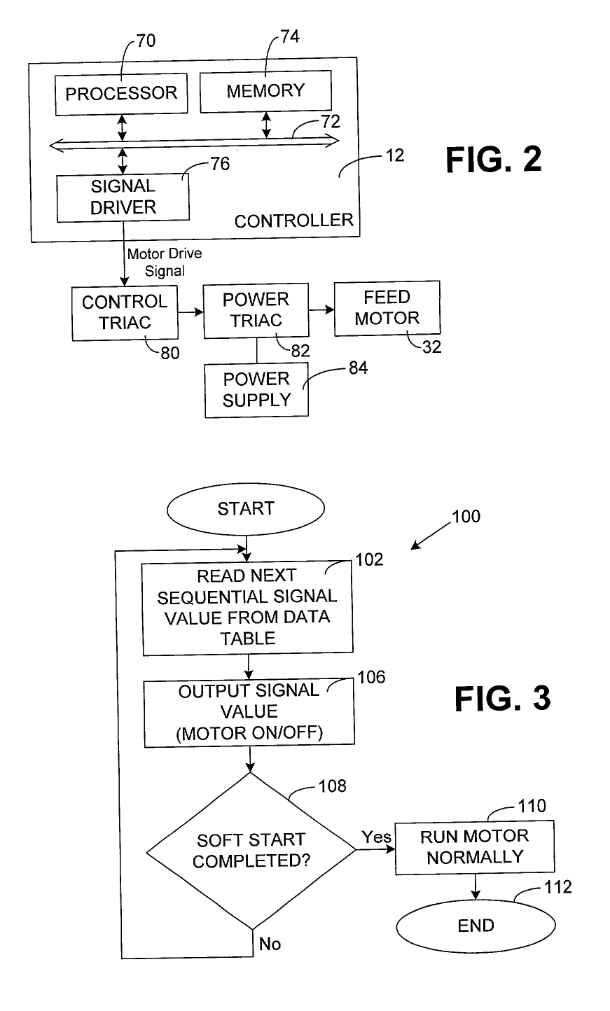

Referring now to FIG. 2, a block diagram of the system controller 12 and the connection of the system controller 12 to the feed motor 32 are shown in accordance with a preferred embodiment of the present invention. The system controller 12 preferably includes a central processing unit, or processor 70, which is coupled to a bus 72, or other local interconnect means as is known in the art. The processor 70 can be any of a plurality of commonly available processors. The processor 70 executes logic to perform the various operations described herein, as well as carry out other operations related to the packaging system controller 12. The manner in which the processor 70 can be programmed to carry out the functions related to the present invention will be readily apparent to those having ordinary skill in the art based on the description provided herein. The bus 72 includes a plurality of signal lines for conveying addresses, data and control information between the processor 70 and a number of system bus components. The other system bus components include a memory 74 (including volatile and non-volatile memories, such as random access memory (RAM) and read only memory (ROM)) and a plurality of ports for connection to a variety of input/output (I/O) devices. The memory 74 serves as data storage and may store appropriate operating code to be executed by the processor 70 for carrying out the functions described herein.

The I/O devices include a signal driver 76. The signal driver 76 is used to generate a motor drive signal under the direction of the processor 70 as described in more detail below. Additional I/O devices can include additional devices, such as a conversion machine user panel with various operational switches, buttons and keys, machine sensors, etc.

With continued reference to FIG. 2, the signal driver 76 is connected to a control triac 80, such as conventional optical coupler for providing optical isolation between the controller 12 and devices external to the controller 12. The control triac 80, in turn, controls a power triac 82 for supplying power from an AC power source 84 to the feed motor 32. The triac 80, 82 arrangement is well known in the art. It is noted that the triacs 80, 82 are configured to be gated, or turned on, at the zero crossings of an AC power source 84. The AC power source 84 is preferably a single phase 110-125 volt power supply operating at a frequency of 60 Hz. However, as one skilled in the art will appreciate, other power sources and operational frequencies are contemplated by the invention, including a 50 Hz power supply as found in Europe. The feed motor 32 is compatible with the power source 84 and is preferably a single phase, fractional horsepower electrical motor.

The control triac 80 is controlled (i.e., gated, or turned on) by the motor drive signal output from the signal driver 76. As will become more apparent from the following, the motor drive signal is used to directly control the speed and acceleration of the feed motor 32. In the preferred embodiment, the motor drive signal is either logically low (e.g., about zero volts) or logically high (e.g., about 3 to 5 volts). In the illustrated embodiment, a logically low signal applied to the input of the optical isolation control triac 80 will allow the output of the control triac 80 to turn on at the next zero crossing of the AC power source 84 (i.e., a motor power on state). The control triac 80 will remain on throughout the subsequent half cycle of the AC power source 84. A logically high signal output from the optical coupler 78 will turn the control triac 80 off at the next zero crossing of the AC power source 80 (i.e., a motor power off state). The control triac 80 will remain off for the subsequent half cycle of the AC power source 84. The power triac 82 is controlled by the control triac 80 in similar fashion. More specifically, for each half cycle that the control triac 80 is on, the power triac 82 will also be on and for each half cycle that the control triac 80 is off, the power triac 82 will also be off. A half cycle, as used herein, is the period from one AC zero crossing to the next zero crossing.

As mentioned above, the feed motor 32 receives operational power from the power triac 82. For each half cycle that the power triac 82 is on, power is supplied to the feed motor 32 and the feed motor 32 will rotate. For each half cycle that the power triac 82 is off, no power will be supplied to the feed motor 32 and the feed motor 32 will not be driven.

As should be apparent, the motor drive signal output from the signal driver 76 results in a direct correlation to which AC power half cycles and/or full cycles the feed motor 32 receives power. Therefore, the motor drive signal can be used to control the speed and acceleration of the feed motor 32 by serially outputting a dynamic motor drive signal. The feed motor 32 will accelerate and run faster as the ratio of “motor on” power source 84 half cycles to “motor off” power source 84 half cycles increases. Although the motor drive signal is composed of logical highs and lows, one skilled in the art will appreciate that other signals representing on and off can be output from the signal driver 76 to act as the motor driver signal. In addition, various modifications to the motor drive circuit, including the controller 12, the control triac 80 and the power triac 82 are not only considered to fall within the scope of the present invention, but may result in corresponding changes to the motor drive signal also considered to fall within the scope of the present invention.

Referring now to FIGS. 2 and 3, a software routine, or motor control logic 100, for controlling the speed and acceleration of the feed motor 32 will be described in greater detail. Although the invention was made in the context of a cushioning conversion machine, the software controlled motor arrangement described herein can be used for the cut motor 38 or in any other environment, including environments unrelated to cushioning conversion machines, where control over motor speed and acceleration is desired.

The motor control logic 100 is directed to a soft start of the feed motor 32. A soft start, as used herein, refers to the gradual increasing of speed of the targeted motor before the motor reaches full speed, or a steady state. However, the motor control logic 100 can easily be modified to control the slowing down of a motor or controlling the motor at any point during its run cycle.

The motor control logic 100 is stored in the memory 74 of the controller 12 and executed by the processor 70. Generally, the motor control logic 100 contains instructions for generating the motor drive signal output from the signal driver 76 and used to control which AC power half cycles the feed motor 74 is on and which AC power half cycles the feed motor 32 is off.

The motor control logic 100 is executed to invoke a soft start of the feed motor 32 each time the feed motor 32 is started to advance the paper 26. The motor control logic 100 begins in step 102 by reading a signal value from a data table.

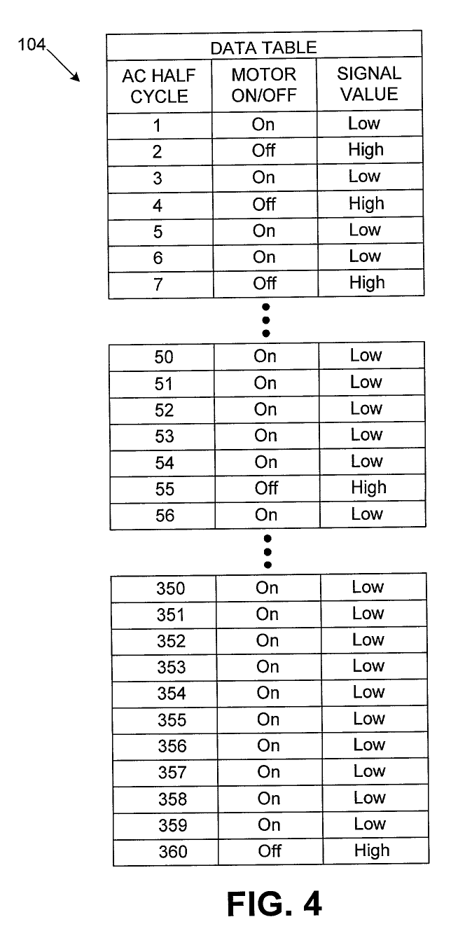

With additional reference to FIG. 4, an exemplary data table 104 for the motor control logic 100 is illustrated. The exemplary data table 104 specifies for each half cycle whether the feed motor 32 should be on or off. For each half cycle a corresponding signal value for the motor drive signal is also specified. The data table 104 is stored in memory 74 to be accessible by the processor 70 during step 102. As one skilled in the art will appreciate, the data table 104 can take on various forms in order to make efficient use of memory space. More specifically, the data table 104 can be reduced to a single series of binary values stored in an array, where each sequential value respectfully represents a motor off or motor on condition. As illustrated in FIG. 4, the AC half cycles are numbered starting at one. The first AC half cycle corresponds to the initial starting of the feed motor 32. The last AC half cycle number in the data table 104, 360 in the illustrated example, represents the last AC cycle controlled by the motor control logic 100 before running the feed motor 32 at a steady state.

When the feed motor 32 is initially started, the motor control logic 100 in step 102 will read the first signal value, or the signal value corresponding to AC cycle number one. Next, the motor control logic 100 will output that signal value in step 106. The read signal value is output via the signal driver 76 based on the content of the data table 104 as the motor drive signal supplied to the control triac. It is noted that the signal driver 76 is tasked with outputting a motor drive signal value appropriate to drive the control triac. Therefore, the signal driver will output the appropriate voltage, current, frequency modulated signal, phase modulated signal or data stream for the triacs 80, 82.

Next, the motor control logic 100 will determine whether the soft start of the feed motor 32 is complete and the feed motor 32 should be run at a steady state in step 108. In a first embodiment, the completion of the soft start is detected by determining whether all of the data values stored in the data table 104 have been read in step 102 and output in step 106. If all of the values have been processed, the soft start is considered complete in step 108 and the motor control logic 100 will proceed to step 110 where the feed motor 32 is run normally, or at a steady state. More specifically, to run the feed motor 32 at a steady state, the signal driver 76 outputs a continuous motor drive signal corresponding to the motor on state. Once the motor has been run for a length of time sufficient to generate the cushioning material pad 24 of the desired length, the feed motor 32 is turned off by outputting a continuous motor drive signal corresponding to the motor off state and the motor control logic 100 finishes its programmed routine in step 112. In another embodiment, the completion of the soft start in step 108 is determined by the expiration of a predetermined amount of time. For example, if the desired soft start is to last for 600 ms, a 600 ms timer can be used to regulate the motor control logic 100.

If the soft start has not been completed in step 108 the motor control logic 100 will return to step 102 where the processor 70 will read the next value from the data table in step 102 and output that value in step 106. A software counter can be used to track the number of signal values previously read, and thus the number of AC half cycles lapsed, as a data management tool to correctly extract the next sequential data value from the data table 104. As previously mentioned, the triacs 80, 82 can be turned on or off for each half cycle of the AC power source 84. For a 60 Hz AC power supply, each half cycle has a duration of approximately 8.33 ms. To coordinate with the AC power source 84 the motor control logic 100 is timed to progress through steps 102, 106 and 108 at twice the frequency of the AC power source 84 (i.e., once every half cycle), or in the example herein approximately every 8.33 ms. It is noted that if the AC power source 84 has a different operating frequency, such as 50 Hz, the execution timing of the motor control logic 100 should be adjusted to correspond to the frequency of the AC power source 84 (e.g., every 10 ms for a 50 Hz power supply).

With continued reference to FIG. 4, the exemplary data table 104 with signal values for controlling when the feed motor is on and when the feed motor 32 is off will be discussed in more detail. In general, the feed motor 32 is turned on for one or more consecutive power half cycles and then turned off for one or more consecutive power half cycles. It is noted however, that too many consecutive off cycles will cause the feed motor to rotate in an excessively unsmooth, or jerky manner. It is more desirable to have smoother motor acceleration. One way to accomplish smoother acceleration is to limit the consecutive number of motor off half cycles to one or two half cycles. Accordingly, the exemplary data table 104 shows the feed motor 32 on for the first half cycle then off for the second half cycle. This is repeated during the third and fourth half cycles.

Subsequently, the feed motor 32 is turned on for progressively longer on periods with only one off half cycle between each on period. For example, in the illustrated data table 104 the motor is turned on during half cycles five and six and then off during half cycle seven. At this point the feed motor 32 is powered for a higher percentage of time and will start to rotate even faster than during the first four AC half cycles. This approach continues as scripted by the predetermined values programmed into the data table 104. For example, in AC half cycles fifty through fifty-four the feed motor 32 is turned on and then turned off for one half cycle. As the feed motor 32 nears the end of the soft start, the feed motor 32 is almost continuously left on for example, through ten or more half cycles, and then turned off for just one half cycle as illustrated for cycles 350 through 360.

The intermittent powering of the feed motor 32 scripted by the contents of the data table 104 results in slower acceleration of the paper 26. Therefore, any slack present in the paper 26 after the generation of the preceding cushioning material pad 24 as a result of stock material 22 overrun will be taken up more gradually. Thereafter, the roll of stock material 22 will start to move in a smoother fashion with a reduced number and intensity of tension spikes in the paper 26. As a result, one should expect less tearing of the paper (or other stock material) 26. As one skilled in the art will appreciate, the motor control logic 100 described above can be easily modified to provide a motor soft stop to progressively decelerate the paper 26 after a cushioning material pad 24 has been generated. The progressive deceleration of paper 26 should reduce the amount of stock material 22 overrun. The motor soft stop can be implemented by reading signal values from a soft stop data table and outputting those signal values similar to the fashion in steps 102, 106 and 108 but where the signal values progressively decrease from longer on periods to longer off periods.

Although particular embodiments of the invention have been described in detail, it is understood that the invention is not limited correspondingly in scope, but includes all changes, modifications and equivalents coming within the spirit and terms of the claims appended hereto. For example, the triacs 80, 82 could be replaced with other switching or power control circuitry. In another example variation, the motor drive signal controls the power delivered to the motor for each full AC cycle rather than for each half cycle.

What is claimed is:

1. A cushioning conversion system for converting a sheet-like stock material into a section of dunnage, the system comprising:
a feed motor operatively connected to advance the stock material; and
a controller for controlling the speed of the feed motor, the controller progressively increasing the speed of the feed motor at the beginning of a dunnage generation cycle.

2. A cushioning conversion system for converting a sheet-like stock material into a section of dunnage, the system comprising:
a feed motor operatively connected to advance the stock material under the control of a motor control signal, the motor control signal having a series of sequential values corresponding to either a motor power on state or a motor power off state; and
a controller, the controller generating the motor control signal by executing a motor control logic routine.

3. The cushioning conversion system according to claim 2, further comprising a triac operatively coupled to the controller, the triac being placed in the motor on state or the motor off state by the motor control signal for each half cycle of an AC power supply.

4. The cushioning conversion system according to claim 3, wherein the triac is a control triac for controlling a power triac, the power triac being connected to the feed motor to deliver electrical power to the feed motor.

5. The cushioning conversion system according to claim 2, wherein the feed motor and the controller are optically isolated.

6. The cushioning conversion system according to claim 2, wherein the controller further includes a signal driver for outputting the motor control signal from the controller.

7. The cushioning conversion system according to claim 2, wherein the motor control logic routine includes the steps of:
reading a signal value from a data table; and
outputting a motor control signal corresponding to the signal value.

8. The cushioning conversion system according to claim 7, wherein the data table is populated with predetermined signal values to invoke a soft start in the feed motor.

9. The cushioning conversion system according to claim 8, wherein the motor control logic routine further includes the steps of determining whether the soft start is complete and running the feed motor at a steady state upon completion of the soft start.

10. The cushioning conversion system according to claim 2, wherein the motor control signal is effective to control rotational speed of the motor.

11. A method of controlling a cushioning conversion machine, the method comprising the steps of:
generating a motor control signal, the motor control signal having a series of sequential values corresponding to either a motor power on state or a motor power off state; and
operatively coupling the motor control signal to a triac to selectively place the triac in the motor on state or the motor off state, the triac being coupled to a feed motor connected to advance a web of stock material, and the triac controlling during which of a plurality of AC power half cycles the motor receives power.

12. The method according to claim 11, further comprising the step of electrically isolating the triac from a controller, the controller generating the motor control signal.

13. A method of controlling a cushioning conversion machine, the method comprising the steps of:
executing a motor control logic routine to generate a motor control signal, the motor control signal having a series of sequential values corresponding to either a motor power on state or a motor power off state; and
controlling the speed of a feed motor connected to advance a web of stock material with the motor control signal;
wherein for each value of the motor control signal, the motor control logic routine includes the steps of:
reading a predetermined signal value from a data table; and
outputting the motor control signal corresponding to the signal value.

14. The method according to claim 13, wherein the predetermined signal values invoke a soft start in the feed motor.

15. The method according to claim 14, wherein the motor control logic further includes the steps of determining whether the soft start is complete and running the feed motor at a steady state upon completion of the soft start.

16. A motor control system, comprising:
a processor, the processor being programmed to read a series of predetermined sequential values corresponding to either a motor power on state or a motor power off state from a memory; and
a signal driver, the signal driver outputting a motor control signal corresponding to the sequential values read by the processor, the motor control signal being effective to control the rotational speed of a motor.

17. The motor control system according to claim 16, further comprising a triac operatively coupled to the signal driver, the triac being turned on or off by the motor control signal for each half cycle of an AC power supply.

18. The motor control system according to claim 17, wherein the triac is optically isolated from the signal driver.

19. The motor control system according to claim 16, wherein sequential values are selected to invoke a soft start in a motor.
